(19) United States
(12) Patent Application Publication
(10) Pub. No.: US 2026/0250432 A1
(43) Pub. Date: Aug. 27, 2026

(54) REVERSIBLE CROSSLINKED EXTRUDED PROFILE AND PROCESS

(71) Applicant: Colin Li Pi Shan

(72) Inventor: Colin Li Pi Shan

(21) Appl. No.: 18/992,482

(22) PCT Filed: Jul. 14, 2023
(86) PCT No.: PCT/US2023/027784

§ 371 Date: Jan. 8, 2025

Related U.S. Application Data
(60) Provisional application No. 63/389,707, filed on Jul. 15, 2022.
(60) Provisional application No. 63/389,738, filed on Jul. 15, 2022.

(51) Int. Cl. C08F 8/34; B29C 48/00; B29C 48/09; B29C 48/12; B29K 23/00; C08J 3/24

(52) U.S. Cl. CPC C08F 8/34; B29C 48/022; C08J 3/247; B29C 48/09; B29C 48/12; B29K 2023/0691; C08F 2810/20; C08J 2323/08

(57) ABSTRACT

The present disclosure provides an article. In an embodiment, the article is an extruded profile composed of a crosslinked composition formed from starting materials comprising an ethylene-based polymer, and 2,2,6,6-tetramethyl-4-piperidyl methacrylate disulfide (BiTEMPS methacrylate). This yields an extruded profile that is composed of a crosslinked composition comprising (i) ethylene-based polymer, and (ii) linkages having a Structure 2

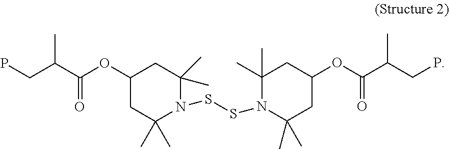

### BACKGROUND

Thermoset, cross-linked polyolefin elastomers are widely used in transportation and infrastructure applications such as automotive weather sealing and under the hood, hoses and belts. One conventional procedure for producing thermoset crosslinked polyolefin elastomers is profile extrusion. In profile extrusion, crosslinking of the polyolefin elastomer via peroxides can create a networked polymer that has improved thermal mechanical properties (such as compression set and creep resistance at elevated temperatures). Peroxide crosslinking creates C—C chemical bonding that is very stable and cannot be further dissociated by heating or mechanical shearing easily, therefore, limited the re-use or re-cycle of postindustrial scrap.

Given the global focus on carbon neutrality and recyclability of plastic materials, the art recognizes the need for thermoset crosslinked extruded profiles that can be reprocessed and/or recycled.

### SUMMARY

The present disclosure provides an article. In an embodiment, the article is an extruded profile composed of a crosslinked composition formed from starting materials comprising an ethylene-based polymer, and 2,2,6,6-tetramethyl-4-piperidyl methacrylate disulfide (BiTEMPS methacrylate). This yields an extruded profile that is composed of a crosslinked composition comprising (i) ethylene-based polymer, and (ii) linkages having a Structure 2

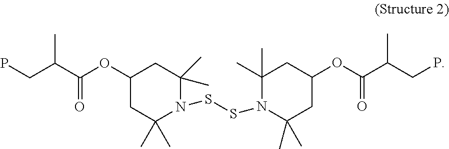

The present disclosure provides a process. In an embodiment, the process includes heating a first article to a reprocessing temperature, the first article composed of an extruded profile composed of a crosslinked composition comprising (i) an ethylene-based polymer, and (ii) linkages having a Structure (2)

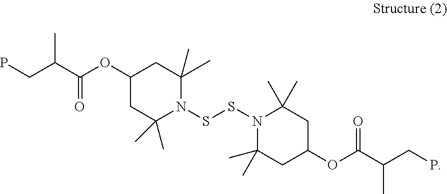

The coating is formed from starting materials of the ethylene-based polymer, and 2,2,6,6-tetramethyl-4-piperidyl methacrylate disulfide (BiTEMPS) methacrylate. The process includes heating the coating to a reprocessing temperature, and forming, at the reprocessing temperature, the coating into a re-processable ethylene-based polymer composition. The process includes shaping, at the reprocessing temperature, the re-processable ethylene-based polymer composition into a re-processed pre-form. The process includes cooling the re-processed pre-form to below the reprocessing temperature and forming a second article composed of a re-crosslinked ethylene-based polymer composition composed of (i) the ethylene-based polymer and (ii) linkages having the Structure (2).

### Definitions

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., a range from 1, or 2, or 3 to 5, or 6, or 7) any subrange between any two explicit values is included (e.g., the range 1-7 above includes subranges from 1 to 2; from 2 to 6; from 5 to 7; from 3 to 7; from 5 to 6; etc.).

Unless stated to the contrary, implicit from the context, or customary in the art, all parts and percentages are based on weight, and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

An “ethylene-based polymer” is a polymer that contains more than 50 mol % polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), ethylene/α-olefin multi-block copolymers (also known as olefin block copolymer (OBC)), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or multiple reactor configurations.

“Ethylene plastomers/elastomers” are substantially linear, or linear, ethylene/α-olefin interpolymers containing homogeneous short-chain branching distribution comprising units derived from ethylene and units derived from at least one C₃-C₁₀ α-olefin comonomer. Ethylene plastomers/elastomers have a density from 0.8540 g/cc to 0.917 g/cc. Nonlimiting examples of ethylene plastomers/elastomers include AFFINITY™ Polyolefin Plastomers and ENGAGE™ Polyolefin Elastomers (available from The Dow Chemical Company), EXACT™ Plastomers (available from ExxonMobil Chemical), Tafmer™ Alpha-olefin copolymers (available from Mitsui), Solumer™ Polyolefin Elastomers and Supreme™ Polyolefin Plastomers (available from SK Chemicals Co.), and Lucene™ Polyolefin Elastomers (available from LG Chem Ltd.).

“High density polyethylene” (or “HDPE”) is an ethylene homopolymer or an ethylene/α-olefin copolymer with at least one C₄-C₁₀ α-olefin comonomer, or C₄-C₈ α-olefin comonomer and a density from 0.940 g/cc, or 0.945 g/cc, or 0.950 g/cc, or 0.953 g/cc to 0.955 g/cc, or 0.960 g/cc, or 0.965 g/cc, or 0.970 g/cc, or 0.975 g/cc, or 0.980 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell), as well as HDPE products from Borealis, Ineos, and ExxonMobil.

“Linear low density polyethylene” (or “LLDPE”) is a linear ethylene/α-olefin copolymer containing homogeneous or heterogeneous short-chain branching distribution comprising units derived from ethylene and units derived from at least one C₃-C₁₀ α-olefin, or C₄-C₈ α-olefin, comonomer. LLDPE is characterized by little, if any, long chain branching, in contrast to conventional LDPE. LLDPE has a density from 0.910 g/cc to less than 0.940 g/cc. Nonlimiting examples of LLDPE include ELITE™ Enhanced Polyethylene Resins, TUFLIN™ linear low density polyethylene resins (available from The Dow Chemical Company), DOWLEX™ polyethylene resins (available from the Dow Chemical Company), and MARLEX™ polyethylene (available from Chevron Phillips).

“Low density polyethylene” (or “LDPE”) consists of ethylene homopolymer, or ethylene/α-olefin copolymer comprising at least one C₃-C₁₀ α-olefin, or C₄-C₈ α-olefin, that has a density from 0.915 g/cc to less than 0.940 g/cc and contains long chain branching with broad MWD. LDPE is typically produced by way of high pressure free radical polymerization (tubular reactor or autoclave with free radical initiator). Nonlimiting examples of LDPE include AGILITY™ Performance LDPE and DOW™ LDPE (available from The Dow Chemical Company), MarFlex™ (Chevron Phillips), LUPOLEN™ (LyondellBasell), as well as LDPE products from Borealis, Ineos, ExxonMobil, and others.

An “olefin-based polymer,” or “polyolefin,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

### Test Methods

Compression Set. Compression set (or “Cset”) was measured using one specimen per sample according to ASTM D395 Method B and Type 1 sample dimension with 25% strain at 70° C. for 22 hours (hr) and 25% strain at 100° C. for 22 hours.

Density was measured in accordance with ASTM D792 with results reported in g/cc at 25° C.

Rheology analysis using Rubber Process Analyzer (RPA). Rheology of the compositions was measured using a rotorless oscillating shear rheometer, Alpha Technologies RPA 2000 instrument, according to ASTM D6204, under the following test conditions and exceptions. The sample was placed between two pieces of Mylar film for analysis. Rheology was monitored during an initial timed test at 160° C., 1.0 rad/s, 7% strain, for 60 min. Elastic torque, S′, at the end of the 60 min crosslinking step was recorded. Immediately following the 60 min at 160° C., a frequency sweep from 0.1 to 300 rad/s was conducted at 160° C., 7% strain on the same sample, followed by a frequency sweep from 0.1 to 300 rad/s at 190° C., 7% strain, and followed by a frequency sweep from 0.1 to 300 rad/s at 230° C., 7% strain. The dynamic complex viscosity, n*, and tan delta were recorded for each frequency sweep. In ASTM D6204, frequency sweeps on unvulcanized rubber are conducted prior to a cure step. In this case, frequency sweeps were conducted after the initial crosslinking step at 160° C. to evaluate the reversibility of the crosslinking.

Dynamic mechanical analysis (DMA). DMA experiments are conducted using a TA Instruments RSA-G2 Solid Analyzer to measure the storage modulus (G′), loss modulus (G″), and damping ratio (tan δ) of networks as a function of temperature and recycling under a nitrogen atmosphere. DMA is operated in tension mode at a frequency of 1 Hz with a 0.03% oscillatory strain. Data is collected from room temperature to 160° C. with a heating rate of 3° C./minute.

Melt index (MI or I₂) (for ethylene-based polymers) is measured in accordance with ASTM D 1238, Condition 190° C./2.16 kg with results reported in grams per 10 minutes (g/10 min).

Tensile Measurements @ 80° C. The tensile measurements were performed according to ASTM D1708 standards, at a 1 inch/min extension speed on an INSTRON equipment. The tensile bars were prepared by die cutting from the compression molded sheet with thickness of 1.5 mm. The testing was performed in an environmental chamber with temperature equilibrated at 80° C. for 30 min before testing. Here, the tensile strength was recorded to reflect whether the materials has crosslinked properties, which is the maximum stress applied before the breaking of the samples. These parameters were averaged by 3 repeated tensile measurements. Compared to a non-crosslinked part, a crosslinked part typically has a significantly higher tensile strength at break.

### DETAILED DESCRIPTION

The present disclosure is directed to an article. The article includes an extruded profile. The extruded profile is composed of a crosslinked polymer composition formed from starting materials comprising (i) an ethylene-based polymer and (ii) 2,2,6,6-tetramethyl-4-piperidyl methacrylate disulfide (BiTEMPS methacrylate).

### A. Extruded Profile

The present disclosure is directed to an article that includes, or otherwise is, an extruded profile. An “extruded profile” (or “profile”), as used herein, is a three-dimensional shaped object composed of a polymeric composition and having a length, a width, and a height, the shaped object having a constant cross-sectional shape along the length thereof. The cross-sectional shape is constant (or otherwise is uniform) along the entire length, or along substantially the entire length, of the shaped object. The extruded profile is formed by forcing a melted polymeric composition through a die outlet and cooling the melted polymer upon exit from the die outlet. Nonlimiting examples of (constant) cross-sectional shapes for the extruded profile include circle, ellipse, polygon, ring, triangle, square, and rectangle. Nonlimiting examples of extruded profile include, film, fiber, bar, rod, tube, pipe, sheet, rubber tube, extruded automotive rubber profile, and weatherstripping.

### B. Ethylene-Based Polymer

The article including (or that is) the extruded profile is formed from a crosslinkable polymer composition (interchangeably referred to as “starting materials”) that includes an ethylene-based polymer. The ethylene-based polymer can be an ethylene homopolymer, an ethylene/C₃-C₁₀ α-olefin copolymer, or an ethylene C₄-C₈ α-olefin copolymer. The ethylene-based polymer has a melt index (MI) from 0.1 g/10 min to 100 g/10 min, or from 1 g/10 min to 100 g/10 min, or from 1 g/10 min to 50 g/10 min, or from 1 g/10 min to 25 g/10 min, or from 1 g/10 min to 10 g/10 min, or from 1 g/10 min to 5 g/10 min. Nonlimiting examples of suitable ethylene-based polymer include ethylene plastomer/elastomer, high density polyethylene (HDPE), linear low density polyethylene (LLDPE), low density polyethylene (LDPE), ethylene/α-olefin multi-block copolymer, and combinations thereof.

In an embodiment, the ethylene-based polymer is an ethylene plastomer/elastomer.

In an embodiment, the ethylene-based polymer is HDPE.

In an embodiment, the ethylene-based polymer is LLDPE.

In an embodiment, the ethylene-based polymer is an ethylene/α-olefin multi-block copolymer. The term “ethylene/α-olefin multi-block copolymer” refers to an ethylene/C₄-C₈ α-olefin multi-block copolymer consisting of ethylene and one copolymerizable C₄-C₈ α-olefin comonomer in polymerized form (and optional additives), the polymer characterized by multiple blocks or segments of two polymerized monomer units differing in chemical or physical properties, the blocks joined (or covalently bonded) in a linear manner, that is, a polymer comprising chemically differentiated units which are joined end-to-end with respect to polymerized ethylenic functionality. Ethylene/α-olefin multi-block copolymer includes block copolymer with two blocks (di-block) and more than two blocks (multi-block). The C₃-C₈ α-olefin is selected from propylene, butene, hexene, and octene. The ethylene/α-olefin multi-block copolymer is void of, or otherwise excludes, styrene (i.e., is styrene-free), and/or vinyl aromatic monomer, and/or conjugated diene. When referring to amounts of “ethylene” or “comonomer” in the copolymer, it is understood that this refers to polymerized units thereof. In some embodiments, the ethylene/α-olefin multi-block copolymer can be represented by the following formula: (AB)ₙ; where n is at least 1, preferably an integer greater than 1, such as 2, 3, 4, 5, 10, 15, 20, 30, 40, 50, 60, 70, 80, 90, 100, or higher, “A” represents a hard block or segment, and “B” represents a soft block or segment. The As and Bs are linked, or covalently bonded, in a substantially linear fashion, or in a linear manner, as opposed to a substantially branched or substantially star-shaped fashion. In other embodiments, A blocks and B blocks are randomly distributed along the polymer chain. In other words, the block copolymers usually do not have a structure as follows: AAA-AA-BBB-BB. In an embodiment, the ethylene/α-olefin multi-block copolymer does not have a third type of block, which comprises different comonomer(s). In another embodiment, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

In an embodiment, ethylene comprises the majority mole fraction of the whole ethylene/α-olefin multi-block copolymer, i.e., ethylene comprises at least 50 wt % of the whole ethylene/α-olefin multi-block copolymer. More preferably, ethylene comprises at least 60 wt %, at least 70 wt %, or at least 80 wt %, with the substantial remainder of the whole ethylene/α-olefin multi-block copolymer comprising the C₃-C₈ α-olefin comonomer. In an embodiment, the ethylene/α-olefin multi-block copolymer contains 50 wt % to 90 wt % ethylene, or 60 wt % to 85 wt % ethylene, or 65 wt % to 80 wt % ethylene. For many ethylene/octene multi-block copolymers, the composition comprises an ethylene content greater than 80 wt % of the whole ethylene/octene multi-block copolymer and an octene content of from 10 wt % to 15 wt %, or from 15 wt % to 20 wt % of the whole multi-block copolymer.

The ethylene/α-olefin multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of monomers other than ethylene) is greater than 5 wt %, or greater than 8 wt %, greater than 10 wt %, or greater than 15 wt %, based on the weight of the polymer. In an embodiment, the comonomer content in the soft segments is greater than 20 wt %, greater than 25 wt %, greater than 30 wt %, greater than 35 wt %, greater than 40 wt %, greater than 45 wt %, greater than 50 wt %, or greater than 60 wt % and can be up to 100 wt %.

The soft segments can be present in an ethylene/α-olefin multi-block copolymer from 1 wt % to 99 wt % of the total weight of the ethylene/α-olefin multi-block copolymer, or from 5 wt % to 95 wt %, from 10 wt % to 90 wt %, from 15 wt % to 85 wt %, from 20 wt % to 80 wt %, from 25 wt % to 75 wt %, from 30 wt % to 70 wt %, from 35 wt % to 65 wt %, from 40 wt % to 60 wt %, or from 45 wt % to 55 wt % of the total weight of the ethylene/α-olefin multi-block copolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, entitled “Ethylene/α-Olefin Block Inter-Polymers,” filed on Mar. 15, 2006, in the name of Colin L. P. Shan, Lonnie Hazlitt, et. al. and assigned to Dow Global Technologies Inc., the disclosure of which is incorporated by reference herein in its entirety. In particular, hard and soft segment weight percentages and comonomer content may be determined as described in column 57 to column 63 of U.S. Pat. No. 7,608,668.

The ethylene/α-olefin multi-block copolymer comprises two or more chemically distinct regions or segments (referred to as “blocks”) joined (or covalently bonded) in a linear manner, that is, it contains chemically differentiated units which are joined end-to-end with respect to polymerized ethylenic functionality, rather than in pendent or grafted fashion. In an embodiment, the blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present ethylene/α-olefin multi-block copolymer is characterized by unique distributions of both polymer polydispersity (PDI or Mw/Mn or MWD), polydisperse block length distribution, and/or polydisperse block number distribution, due, in an embodiment, to the effect of the shuttling agent(s) in combination with multiple catalysts used in their preparation.

In an embodiment, the ethylene/α-olefin multi-block copolymer is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/α-olefin multi-block copolymer possesses Mw/Mn from 1.0 to 3.5, or from 1.3 to 3, or from 1.4 to 2.5, or from 1.4 to 2.

In addition, the ethylene/α-olefin multi-block copolymer possesses a PDI (or Mw/Mn) fitting a Schultz-Flory distribution rather than a Poisson distribution. The present ethylene/α-olefin multi-block copolymer has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phys. (1997) 107 (21), pp 9234-9238.

In an embodiment, the present ethylene/α-olefin multi-block copolymer possesses a most probable distribution of block lengths.

In a further embodiment, the ethylene/α-olefin multi-block copolymer of the present disclosure, especially those made in a continuous, solution polymerization reactor, possess a most probable distribution of block lengths. In one embodiment of this disclosure, ethylene/α-olefin multi-block copolymers are defined as having:
(A) Mw/Mn from about 1.7 to about 3.5, at least one melting point, Tm, in degrees Celsius, and a density, d, in grams/cubic centimeter, wherein the numerical values of Tm and d correspond to the relationship:

$$Tm > - 200 \; 2.9 + 4538.5 ( d ) - 2422.2 {( d )}^{2} , and / or$$

(B) Mw/Mn from about 1.7 to about 3.5, and is characterized by a heat of fusion, DH in J/g, and a delta quantity, DT, in degrees Celsius defined as the temperature difference between the tallest DSC peak and the tallest Crystallization Analysis Fractionation (“CRYSTAF”) peak, wherein the numerical values of DT and DH have the following relationships:

$$DT > - 0.1299 DH + 62.81 for DH greater than zero and up to 130 J / g$$

$$DT \geq 48 ° C . for DH greater than 130 J / g$$

wherein the CRYSTAF peak is determined using at least 5 percent of the cumulative polymer, and if less than 5 percent of the polymer has an identifiable CRYSTAF peak, then the CRYSTAF temperature is 30° C.; and/or
(C) elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene/α-olefin interpolymer is substantially free of crosslinked phase:
   Re>1481-1629 (d); and/or
(D) has a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density and molar comonomer content (based on the whole polymer) within 10 percent of that of the ethylene/α-olefin interpolymer; and/or
(E) has a storage modulus at 25° C., G′ (25° C.), and a storage modulus at 100° C., G′ (100° C.), wherein the ratio of G′ (25° C.) to G′ (100° C.) is in the range of 1:1 to 9:1.

The ethylene/α-olefin multi-block copolymer may also have:
(F) a molecular fraction which elutes between 40° C. and 130° C. when fractionated using TREF, characterized in that the fraction has a block index of at least 0.5 and up to 1 and a molecular weight distribution, Mw/Mn, greater than 1.3; and/or
(G) average block index greater than zero and up to 1.0 and a molecular weight distribution, Mw/Mn greater than 1.3.

It is understood that the ethylene/α-olefin multi-block copolymer may have one, some, all, or any combination of properties (A)-(G). Block Index can be determined as described in detail in U.S. Pat. No. 7,608,668 herein incorporated by reference for that purpose. Analytical methods for determining properties (A) through (G) are disclosed in, for example, U.S. Pat. No. 7,608,668, col. 31 line 26 through col. 35 line 44, which is herein incorporated by reference for that purpose.

In an embodiment, the ethylene/α-olefin multi-block copolymer has hard segments and soft segments, is styrene-free, consists of only (i) ethylene and (ii) a C₄-C₈ α-olefin or C₈ α-olefin (and optional additives), and is defined as having a Mw/Mn from 1.7 to 3.5, at least one melting point, Tm, in degrees Celsius, and a density, d, in grams/cubic centimeter, wherein the numerical values of Tm and d correspond to the relationship:

$$Tm > - 200 \; 2.9 + 4538.5 ( d ) - 2422.2 {( d )}^{2} ,$$

where the density, d, is from 0.850 g/cc, or 0.860 g/cc, or 0.870 g/cc to 0.875 g/cc, or 0.877 g/cc, or 0.880 g/cc, or 0.890 g/cc; and the melting point, Tm, is from 110° C., or 115° C., or 120° C. to 125° C., or 130° C., or 135° C.

In an embodiment, the ethylene/α-olefin multi-block copolymer is an ethylene/1-octene multi-block copolymer (consisting only of ethylene and octene comonomer) and has one, some, or all of the following properties:
(i) a Mw/Mn from 1.7, or 1.8 to 2.2, or 2.5, or 3.5; and/or
(ii) a density from 0.860 g/cc, or 0.865 g/cc, to 0.870 g/cc, or 0.877 g/cc, or 0.880 g/cc; and/or
(iii) a melting point, Tm, from 115° C., or 118° C., or 119° C., or 120° C. to 120° C., or 123° C., or 125° C.; and/or
(iv) a melt index (MI) from 0.1 g/10 min, or 0.5 g/10 min to 1.0 g/10 min, or 2.0 g/10 min, or 5 g/10 min, or 10 g/10 min; and/or
(v) from 50 to 85 wt % soft segment and from 40 to 15 wt % hard segment (based on total weight of the ethylene/octene multi-block copolymer); and/or
(vi) from 10 mol %, or 13 mol %, or 14 mol %, or 15 mol % to 16 mol %, or 17 mol %, or 18 mol %, or 19 mol %, or 20 mol % octene in the soft segment; and/or
(vii) from 0.5 mol %, or 1.0 mol %, or 2.0 mol %, or 3.0 mol % to 4.0 mol %, or 5 mol %, or 6 mol %, or 7 mol %, or 9 mol % octene in the hard segment; and/or
(viii) an elastic recovery (Re) from 50%, or 60% to 70%, or 80%, or 90%, at 300% min⁻¹ deformation rate at 21° C. as measured in accordance with ASTM D 1708; and/or
(ix) a polydisperse distribution of blocks and a polydisperse distribution of block sizes (hereafter referred to as multi-block copolymer properties (i)-(ix)).

In an embodiment, the ethylene/α-olefin multi-block copolymer is an ethylene/octene multi-block copolymer. The ethylene/octene multi-block copolymer is sold under the tradename INFUSE™, available from The Dow Chemical Company, Midland, Michigan, USA.

The ethylene/α-olefin multi-block copolymer can be produced via a chain shuttling process such as described in U.S. Pat. No. 7,858,706, which is herein incorporated by reference. In particular, suitable chain shuttling agents and related information are listed in col. 16 line 39 through col. 19 line 44. Suitable catalysts are described in col. 19 line 45 through col. 46 line 19 and suitable co-catalysts in col. 46 line 20 through col. 51 line 28. The process is described throughout the document, but particularly in col. 51 line 29 through col. 54 line 56. The process is also described, for example, in the following: U.S. Pat. Nos. 7,608,668; 7,893,166; and 7,947,793.

### C. Free Radical Initiator

The crosslinkable polymer composition from which the extruded profile is formed includes a free radical initiator. In an embodiment, the free radical initiator is an organic peroxide. Nonlimiting examples of suitable organic peroxide include bis(1,1-dimethylethyl) peroxide; bis(1,1-dimethylpropyl) peroxide; 2,5-dimethyl-2,5-bis(1,1-dimethylethylperoxy) hexane; 2,5-dimethyl-2,5-bis(1,1-dimethylethylperoxy) hexyne; 4,4-bis(1,1-dimethylethylperoxy) valeric acid; butyl ester; 1,1-bis(1,1-dimethylethylperoxy)-3,3,5-trimethylcyclohexane; benzoyl peroxide; tert-butyl peroxybenzoate; di-tert-amyl peroxide (“DTAP”); bis(α-t-butyl-peroxyisopropyl)benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3,1,1-bis(t-butylperoxy)-3,3,5-trimethylcyclohexane; isopropylcumyl cumylperoxide; butyl 4,4-di(tert-butylperoxy) valerate; di(isopropylcumyl) peroxide; dicumyl peroxide, and combinations thereof.

In an embodiment the free radical initiator is dicumyl peroxide.

### D. BiTEMPS Methacrylate

The crosslinkable polymer composition from which the extruded profile is formed includes 2,2,6,6-tetramethyl-4-piperidyl methacrylate disulfide, interchangeably referred to as “BiTEMPS methacrylate,” or “BiTEMPS” or “BIT.” BiTEMPS methacrylate disulfide has the Structure 1 below.

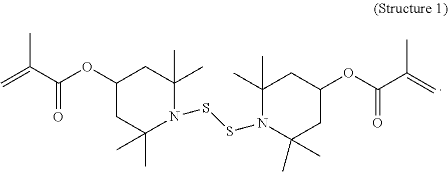 [SMILES: C=C(C)C(=O)OC1CC(C)(C)N(SSN2C(C)(C)CC(OC(=O)C(=C)C)CC2(C)C)C(C)(C)C1]

In an embodiment, the crosslinkable polymer composition includes
from 70 wt % to 98.5 wt %, or from 77 wt % to 98.5 wt % of the ethylene-based polymer;
from 0.1 wt % to 10 wt %, or from 0.1 wt % to 5 wt % 0.1 wt % to 3.0 wt % or from 0.1 wt % to 1.5 wt %, or from 0.5 wt % to 1.5 wt % free radical initiator that is an organic peroxide (such as dicumyl peroxide for example); and
from 1 wt % to 20 wt %, or from 1 wt % to 15 wt %, or from 2 wt % to 20 wt %, or from 2 wt % to 10 wt % BiTEMPS methacrylate disulfide. It is understood that the aggregate of the ethylene-based polymer, the free radical initiator, and the BiTEMPS methacrylate disulfide (and optional additives) amount to 100 wt % of the crosslinkable polymer composition.

The crosslinked composition for the extruded profile is formed from the crosslinkable polymer composition. The crosslinkable polymer composition is melt blended at a temperature from 100° C. to 250° C., or from 120° C. to 210° C., or from 140° C. to 210° C., or from 140° C. to 190° C. to trigger the crosslinking reaction and form the crosslinked composition. In an embodiment, the crosslinked composition includes an ethylene-based polymer and 2,2,6,6-tetramethyl-4-piperidyl methacrylate disulfide (BiTEMPS methacrylate). The crosslinked composition contains disulfide linkages formed from the BiTEMPS methacrylate by way of the crosslinking reaction, the disulfide linkages having the Structure 2 below.

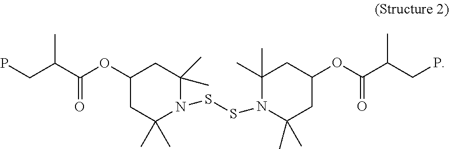

The term (and structure) “P” in Structure 2 above refers to the chain of polymerized ethylene (and optional comonomer(s)) for the ethylene-based polymer. The ethylene-based polymer of the crosslinked composition can be any ethylene-based polymer with a MI from 0.1 g/10 min to 100 g/10 min as previously disclosed herein. Nonlimiting examples of suitable ethylene-based polymer include ethylene plastomer/elastomer, high density polyethylene (HDPE), linear low density polyethylene (LLDPE), low density polyethylene (LDPE), ethylene/α-olefin multi-block copolymer, and combinations thereof.

In an embodiment, the ethylene-based polymer is a virgin ethylene-based polymer. A “virgin ethylene-based polymer,” as used herein, is an ethylene-based polymer that has not been subjected to a crosslinking reaction. In other words, the term “virgin ethylene-based polymer” refers to the ethylene-based polymer that is present in the crosslinked composition prior to the ethylene-based polymer being crosslinked with the BiTEMPS methacrylate. The virgin ethylene-based polymer is the ethylene-based polymer prior to crosslinking, the crosslinked composition containing the same ethylene-based polymer that was virgin, but is now crosslinked with BiTEMPS methacrylate. In this way, the virgin ethylene-based polymer serves as a baseline to evaluate the properties of the crosslinked composition. The crosslinked composition has
(i) a storage modulus value, G′, at 140° C. that is greater than the storage modulus value, E′, for the virgin ethylene-based polymer at 140° C.;
(ii) a tan delta value at 60° C. that is less than the tan delta value of the virgin ethylene-based polymer at 60° C.; and
(iii) a tan delta value at 140° C. that is less than the tan delta value of the virgin ethylene-based polymer at 140° C.,
and is formed into the extruded profile as disclosed above.

In an embodiment, the crosslinked composition includes from 80 wt % to 99.9 wt %, or from 80 wt % to 97 wt % of the ethylene-based polymer and linkages having the Structure (2) (formed from 2 wt % to 20 wt % BiTEMPS methacrylate), the aggregate of the ethylene-based polymer and the linkages of Structure (2) (formed from the BiTEMPS methacrylate) (and optional additives) amounting to 100 wt % of the crosslinked composition. The crosslinked composition of the extruded profile has
(i) a storage modulus value, G′, at 60° C. greater than 1 MPa;
(ii) a storage modulus value, G′, at 140° C. greater than 0.1 MPa;
(iii) a tan delta value at 60° C. less than 0.17; and
(iv) a tan delta value at 140° C. less than 0.62.

### E. Blend Component

In an embodiment, the crosslinkable polymer composition and/or the crosslinked composition includes a blend component. Nonlimiting examples of suitable blend component include ethylene vinyl acetate (EVA), polyolefins (e.g., polyethylene other than the ethylene-based polymer crosslinked with BiTEMPS methacrylate and polypropylene), polymers (e.g., polystyrene, ABS, SBS and the like) and combinations thereof. Non-limiting examples of suitable polyolefins include polyethylene; polypropylene; polybutylene (e.g., polybutene-1); polypentene-1; polyhexene-1; polyoctene-1; polydecene-1; poly-3-methylbutene-1; poly-4-methylpentene-1; polyisoprene; polybutadiene; poly-1,5-hexadiene; interpolymers derived from olefins; interpolymers derived from olefins and other polymers such as polyvinyl chloride, polystyrene, polyurethane, and the like; and mixtures thereof.

In an embodiment, the polyolefin is a homopolymer such as polyethylene, polypropylene, polybutylene, polypentene-1, poly-3-methylbutene-1, poly-4-methylpentene-1, polyisoprene, polybutadiene, poly-1,5-hexadiene, polyhexene-1, polyoctene-1 and polydecene-1.

Nonlimiting examples of suitable polyethylene as blend component (other than the ethylene-based polymer that is crosslinked with BITEMPS methacrylate) include ultra low density polyethylene (ULDPE), linear low density polyethylene (LLDPE), low density polyethylene (LDPE), medium density polyethylene (MDPE), high density polyethylene (HDPE), high molecular weight high density polyethylene (HMW-HDPE), ultra high molecular weight polyethylene (UHMW-PE) and combinations thereof. Nonlimiting examples of polypropylene include low density polypropylene (LDPP), high density polypropylene (HDPP), high-melt strength polypropylene (HMS-PP) and combination thereof. In an embodiment, the blend component is a high-melt-strength polypropylene (HMS-PP), a low density polyethylene (LDPE) or a combination thereof.

### F. Additives

The crosslinkable polymer composition and/or the crosslinked composition may contain one or more optional additives. Nonlimiting examples of suitable additives include grafting initiators, cross-linking catalysts, blowing agent, blowing agent activators (e.g., zinc oxide, zinc stearate and the like), coagents (e.g., triallyl cyanurate), plasticizers, processing oils, processing aids, carbon black, colorants or pigments, stability control agents, nucleating agents, fillers, antioxidants, acid scavengers, ultraviolet (UV) stabilizers, flame retardants, lubricants, processing aids, extrusion aids, and combinations thereof. When present, the total amount of additive can be from greater than 0 to 80%, or from 0.001% to 70%, or from 0.01% to 60%, or from 0.1% to 50%, or from 0.1% to 40%, or from 0.1% to 20%, or from 0.1% to 10%, or from 0.1% to 5% of the total weight of the composition.

BiTEMPS methacrylate is a “dynamic crosslinker.” The dynamic crosslinker BiTEMPS methacrylate enables formation of a crosslinked network with the ethylene-based polymer by way of disulfide linkages between the chains of the ethylene-based polymer (in the presence of the free radical initiator) to form the crosslinked ethylene-based polymer composition. The crosslinking is dynamic because the disulfide linkages may be broken, allowing for chain mobility and exchange when the crosslinked ethylene-based polymer composition is subjected to a “reprocessing temperature,” the reprocessing temperature being a temperature from 160° C. to 230° C., or from 160° C. to 200° C. At the reprocessing temperature, the disulfide linkages in the crosslinked ethylene-based polymer composition are broken, forming a re-processable ethylene-based polymer composition. Cooling the re-processable ethylene-based composition below the reprocessing temperature forms a re-crosslinked ethylene-based polymer composition.

The dynamic crosslinker BiTEMPS methacrylate enables a cyclic “reprocessing” for fabrication of new polymeric articles. When the crosslinked ethylene-based polymer composition is heated to the reprocessing temperature, the disulfide linkages break, or otherwise cleave, enabling the previously-crosslinked ethylene-based polymer composition to flow at the reprocessing temperature, forming “a re-processable ethylene-based polymer composition.” Heating to the reprocessing temperature enables link breaking and polymer chain flow, allowing the ethylene-based composition to be reshaped readily. At the reprocessing temperature, the re-processable ethylene-based polymer composition is no longer crosslinked, but rather is flowable, enabling shaping and/or fabrication of the now flowable re-processable ethylene-based composition (with BiTEMPS methacrylate) into a new pre-form or article. Upon cooling to below the “reprocessing temperature,” the disulfide linkages form again, the network is re-established, and the re-crosslinked ethylene-based compositions is formed in the new article configuration with a return to the high viscosity (no flow at room temperature) and resistance to mechanical deformation indicative of the crosslinked network. When the newly-formed article of the re-processable ethylene-based polymer composition is cooled below the reprocessing temperature, the disulfide linkages in the re-processable ethylene-based polymer composition are re-established, and the ethylene-based polymer (with BiTEMPS methacrylate) becomes a re-crosslinked ethylene-based polymer composition in the shape of the newly-fabricated article. Below the reprocessing temperature, the network disulfide linkages are stable, and the re-crosslinked ethylene-based polymer composition exhibits the high viscosity and resistance to mechanical deformation indicative of a crosslinked network. This cycle of crosslink/re-process/re-crosslink and fabrication into a new article can be repeated.

Bounded by no particular theory, the number of “reprocessing” cycles that are possible with the present crosslinked ethylene-based composition (before competitive thermal and oxidative permanent crosslinking occurs and prevents further reprocessing), can be determined by calculating the ratio of the melt viscosity of the crosslinked ethylene-based polymer composition before and after a reprocessing cycle. For the crosslinked ethylene-based polymer composition to be re-processable, the ratio of the viscosity after reprocessing to the viscosity before reprocessing is from 0.5 to 5, or from 0.7 to 3 or from 0.9 to 2 or from 0.95 to 1.2.

Other metrics for monitoring the number of “reprocessing” cycles that are possible with the BiTEMPS methacrylate dynamic crosslinker before competitive oxidative permanent crosslinking occurs include visual observation. Formed film that is mechanically deformed is heated to the reprocessing temperature, and is visually inspected to determine whether the mechanically deformed film heals to form a stable film.

### G. Process

The present disclosure provides a process. In an embodiment, the process includes heating a first article to a reprocessing temperature. The first article that is composed of, or otherwise is, an extruded profile. The extruded profile is composed of the crosslinked composition including the ethylene-based polymer, and linkages having the Structure (2) (formed from 2,2,6,6-tetramethyl-4-piperidyl methacrylate disulfide (BiTEMPS methacrylate)). The process includes forming, at the reprocessing temperature, the first article into a re-processable ethylene-based polymer composition. The process includes shaping, at the reprocessing temperature, the re-processable ethylene-based polymer composition into a re-processed pre-form. The process includes cooling the re-processed pre-form to below the reprocessing temperature and forming a second article composed of a re-crosslinked ethylene-based polymer composition composed of (i) the ethylene-based polymer and (ii) the BiTEMPS methacrylate.

The second article can be the same as, or different than the first article.

In an embodiment, the shaping step is a procedure selected from the group consisting of injection molding, extrusion, extrusion molding, thermoforming, slush molding, over molding, insert molding, blow molding, cast molding, tentering, compression molding, and combinations thereof.

Nonlimiting examples of suitable second articles for the present crosslinked/re-crosslinked ethylene-based polymer (with BiTEMPS methacrylate) composition include three-dimensional loop material; extruded profile, elastic film; elastic fiber; soft touch good, such as tooth brush handles and appliance handles; gaskets and profiles; adhesives (including hot melt adhesives and pressure sensitive adhesives); footwear (including shoe soles and shoe liners); auto interior parts and profiles; foam articles (both open cell foam and closed cell foam); impact modifiers for other thermoplastic polymers such as high density polyethylene, isotactic polypropylene, or other olefin polymers; coated fabrics; hoses; tubing; weather stripping; cap liners; flooring; and combinations thereof.

Applicant discovered crosslinked extruded profile that is capable of undergoing reversible crosslinking at reprocessing temperatures. This is achieved by forming extruded profile from a crosslinkable polymer composition of ethylene-based polymer, peroxide, and BITEMPS methacrylate. The inventive compositions form an article composed of, or otherwise is an extruded profile composed of crosslinked composition, wherein the crosslinked composition is crosslinked at application use temperatures, but can be melt reprocessed at typical extruded profile processing temperatures (~160-250° C.). As a result, the proposed solution offers benefits in heat resistance and durability for extruded profiles, while maintaining (re) processability under typical extrusion temperatures.

By way of example, and not limitation, some embodiments of the present disclosure will now be described in detail in the following examples.

### 1. Materials

Materials used in the comparative samples (CS) and inventive examples (IE) are provided in Table 1 below.

TABLE 1
Materials

| Component/Description | Structure/properties | | Source |
|---|---|---|---|
| ENGAGE 8100 (“8100”) | Ethylene/octene copolymer | | The Dow Chemical |
| | d-0.87 g/cc, MI-1 g/10 min, Tₘ: 60° C. | | Company |
| ENGAGE 8842 (“8842”) | Ethylene/octene copolymer | | The Dow Chemical |
| | d-0.857 g/cc, MI-1 g/10 min, Tₘ: 38° C. | | Company |
| INFUSE 9000 (“9000”) | Ethylene/octene multi-block copolymer | | The Dow Chemical |
| | d-0.877 g/cc, MI-0.5 g/10 min, Tₘ: 120° C. | | Company |
| Dicumyl Peroxide (“DCP”) | C₁₈H₂₂O₂ | | Sigma-Aldrich |
| Radical initiator | | | |
| BITEMPS methacrylate | 2,2,6,6-tetramethyl-4-piperidyl methacrylate disulfide (Structure 1) | | Custom synthesis |
| crosslinker | C₂₆H₄₄N₂O₄S₂ | | |
| | 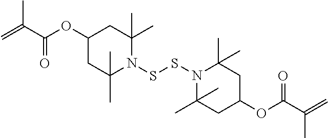 | Structure (1) | |

### 2. Synthesis of BITEMPS Methacrylate

To synthesize BiTEMPS methacrylate, 2,2,6,6-tetramethyl-4-piperidyl methacrylate (8.78 g, 39.0 mmol, supplied by TCI America) is first dissolved in anhydrous petroleum ether (~90 mL, supplied by Sigma-Aldrich, dried over molecular sieves for 48 hr before use) and cooled to −70° C. in a dry ice/acetone bath. Afterward, sulfur monochloride (1.30 g, 9.7 mmol, supplied by Sigma-Aldrich) is dissolved in anhydrous petroleum ether (~1.25 mL) and added dropwise to the reaction vessel over the course of 30 minutes. The solution is stirred at −70° C. for an additional 30 minutes and at room temperature for 15 minutes. Next, BiTEMPS methacrylate is precipitated out by pouring the reaction solution into copious distilled water and stirring at room temperature overnight. The precipitates are collected, vacuum-filtered, and vacuum-dried at 60° C. for 48 hr to obtain BiTEMPS methacrylate, shown as Structure 1 below.

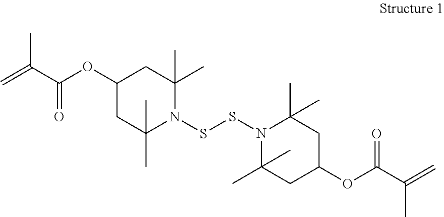

### 3. Formulations

(i) Baseline polyethylene (8842, 9000, 8100), (ii) polyethylene and DCP and (iii) polyethylene, DCP and BiTEMPS methacrylate were combined (in the amounts shown in Table 2 below) and batch mixed at 100° C. to form crosslinkable polymer compositions. The crosslinkable polymer compositions were heated on an RPA at 160° C. for 60 minutes to initiate the crosslinking reaction. Properties of the crosslinked compositions are provided in Table 2 below.

### Table 2: Formulations and Properties

TABLE 2
Formulations and Properties

| | CS1 | CS2 | CS3 | CS4 | CS5 | CS6 |
|---|---|---|---|---|---|---|
| Baseline and | Baseline | Baseline | Baseline | 8842 | 8842 | 9000 |
| crosslinkable | | | | | | |
| compositions (phr) | | | | | | |
| ENGAGE 8842 | 100 | | | 100 | 100 | |
| ENGAGE 8100 | | | 100 | | | |
| INFUSE 9000 | | 100 | | | | 100 |
| Dicumyl peroxide | | | | 1 | 0.5 | 0.5 |
| (DCP) | | | | | | |
| BITEMPS | | | | | | |
| Total (phr) | 100 | 100 | 100 | 101 | 100.5 | |

RPA results from the formulation

| | | | | | | |
|---|---|---|---|---|---|---|
| Crosslinked | ENGAGE 8842 | INFUSE 9000 | ENGAGE 8100 | ENGAGE 8842 | ENGAGE 8842 | INFUSE 9000 |
| compositions | | | | | | |
| Density | 0.857 | 0.877 | 0.87 | 0.857 | 0.857 | |
| Melt Index | 1 | 0.5 | 1 | 1 | 1 | |
| RPA S′ @ 160 C. | 0.07 | 0.3 | | 4.51 | 2.53 | 3.36 |
| RPA TD @ 160 C. | 2.346 | 2.263 | | 0.08 | 0.16 | 0.146 |
| RPA n*(0.1) @160 C. | 23046 | 36774 | | 3411504 | 1701554 | 2331290 |
| RPA n*(300) @160 C. | 887 | — | | 1595 | 1257 | — |
| RPA TD(0.1) @160 C. | | 4.151 | | 0.06 | 0.15 | 0.131 |
| RPA n*(0.1) @230 C. | | 23586 | | 2824153 | 1164458 | 1604753 |
| RPA n*(300) @230 C. | | — | | 1263 | 897 | |
| RPA TD(0.1) @230 C. | | 1.434 | | 0.056 | 0.187 | |
| VRR | — | — | | 1.21 | 1.46 | 1.453 |
| Reprocessable based | Yes | Yes | Yes | No | No | No |
| on Rheology (VRR > 5) | | | | | | |

Measured properties after crosslinking the materials at 180° C. for 15 min

| | | | | |
|---|---|---|---|---|
| Tensile Strength @ | 27 | | | 180 |
| 80 C. (psi) | | | | |
| Cset @ 70 C. (%) | 100 | 100 | 34.2 | |
| Cset@100 C. (%) | | 100 | | |

| | IE1 | IE2 | IE3 | IE4 |
|---|---|---|---|---|
| Baseline and | 8842 BiT | 8100 BiT | 9000 BiT | INFUSE |
| crosslinkable | | | | 9000 ½ |
| compositions (phr) | | | | BiT |
| ENGAGE 8842 | 100 | | | |
| ENGAGE 8100 | | 100 | 100 | 100 |
| INFUSE 9000 | | | | |
| Dicumyl peroxide | 1 | 1 | 1 | 0.5 |
| (DCP) | | | | |
| BITEMPS | 5 | 5 | 5 | 2.5 |
| Total (phr) | 106 | 106 | 106 | 103 |
| RPA results from the formulation | | | | |
| Crosslinked | ENGAGE | ENGAGE | INFUSE | INFUSE |
| compositions | 8842 BTM | 8100 BTM | 9000 BTM | 9000 ½ |
| | | | | BTM |
| Density | | | | |
| Melt Index | | | | |
| RPA S′ @ 160 C. | 2.65 | 2.25 | 3.72 | 1.45 |
| RPA TD @ 160 C. | 0.14 | 0.21 | 0.12 | 0.34 |
| RPA n*(0.1) @160 C. | 1816796 | 1442960 | 2640058 | 841120 |
| RPA n*(300) @160 C. | 1214 | — | 1527 | — |
| RPA TD(0.1) @160 C. | 0.21 | 0.302 | 0.17 | 0.387 |
| RPA n*(0.1) @230 C. | 219976 | 126725 | 416689 | 92421 |
| RPA n*(300) @230 C. | 526 | — | 763 | — |
| RPA TD(0.1) @230 C. | 0.66 | 1.051 | 0.47 | 0.946 |
| VRR | 8.26 | 11.38 | 6.34 | 9.1 |
| Reprocessable based | Yes | Yes | Yes | Yes |
| on Rheology (VRR > 5) | | | | |
| Measured properties after crosslinking the materials at 180° C. for 15 min | | | | |
| Tensile Strength @ | 180 | | | |
| 80 C. (psi) | | | | |
| Cset @ 70 C. (%) | 69.6 | 87 | | |
| Cset@100 C. (%) | | 71 | | |

*Compositions with VRR greater than 5 are re-processable; compositions with VRR less than 5 are not re-processable.

### 4. Crosslinking

Plaques 4″ by 3″ by 1.5 mm or 1 inch diameter and 0.5 inch thick button of crosslinked composition were prepared in a compression molder with 30000 lbf at 180° C. for 15 min. The plaques and buttons were then conditioned for one day at room temperature. Tensile test at 80° C., compression set at 70° C., and compression set at 100° C. were evaluated as reported in Table 2.

TABLE 3
Summarized characteristics for materials that is qualified as a crosslinked profile
parts and considered extrudable based on RPA screening of the compounds.

| Test criteria | | CS1 | CS2 | CS4 | CS5 | CS6 | IE1 | IE2 | IE3 | IE4 |
|---|---|---|---|---|---|---|---|---|---|---|
| Crosslinked | RPA S′ @ | N | N | Y | Y | Y | Y | Y | Y | Y |
| after molding | 160° C. > 1 | | | | | | | | | |
| Reprocessable at | VRR > 5 | — | — | N | N | N | Y | Y | Y | Y |
| 200-230° C. | | | | | | | | | | |

In Table 3, the RPA results are summarized and indicate whether a material was crosslinked based on RPA S′ value, and whether the crosslinked compositions were re-processable based on VRR (i.e., viscosity ratio, VRR=RPA n*(0.1) @160° C./RPA n*(0.1) @230° C.). A high RPA S′ value was an indication that the composition during initial curing step can reach a crosslinked state. The observation of a high S′ value in Table 2 was also found to be consistent with the measured physical properties of the crosslinked materials, including high tensile strength @ 80° C. and relatively low Cset at 70° C. and 100° C. compared to non-crosslinked elastomers.

A high VRR (greater than 5) is needed to reprocess the crosslinked materials during extrusion, or otherwise be reprocessable. This is due to the fact that the viscosity of an irreversibly crosslinked material (a composition with DCP and no BiTEMPS) at a processing temperature such as 230° C., typically does experience a low enough viscosity drop to become extrudable. However, the inventive examples IE1-IE4 each demonstrated a significant drop in viscosity—at least a 5× drop (i.e., VRR>5) at 230° C. due to the breaking down of the disulfide linkages, and thus IE1-IE4 are extrudable and reprocessable.

TABLE 4
Extrusion of Inventive Examples

| | | IE2 | IE2 | IE2 | IE2 | IE4 |
|---|---|---|---|---|---|---|
| | | (crosslinked) | (crosslinked) | (crosslinked) | (crosslinked) | (crosslinked) |
| | ENGAGE | ENGAGE | ENGAGE | ENGAGE | ENGAGE | INFUSE |
| | 8100 Control | 8100 BTM | 8100 BTM | 8100 BTM | 8100 BTM | 90000 ½ |
| | | | | | | BTM |
| Extrusion Temp (° C.) | 200 | 200 | 210 | 230 | 230 | 230 |
| Extrusion Speed | 50 | 25 | 25 | 25 | 50 | 50 |
| (RPM) | | | | | | |
| Extrusion Torque | 26 | 43 | 41 | 30 | 23 | 28 |
| (Nm) | | | | | | |
| Extrudate Color | Clear, | Light Yellow | Orange | Dark Brown | Dark Brown | Light Brown |
| | Transparent | | | | | |

For the extrusion study, the crosslinked plaques were cut up into small pieces using scissors. 20 grams of small pieces of each crosslinked composition were fed into the microcompounder (DSM EXPLORE Microcompounder MC40) operating between 200° C. to 230° C., starting at 25 rpm and increased to 50 rpm (if possible). Extrusion conditions and observation are shown in Table 4.

In Table 4, the extrudability of IE2 and IE4 was confirmed, where each inventive example after crosslinking (i.e., IE2 and IE4 after curing at 180° C. for 15 min) was able to be extruded at temperature between 200-230° C. Particularly, for the extrusion conducted at 230° C., the extruder can be operated at up to 50 RPM, and relatively low torque that was comparable to the ENGAGE 8100 control a non-crosslinked resin extruded at 200° C.

It is specifically intended that the present disclosure not be limited to the embodiments and illustrations contained herein, but include modified forms of those embodiments including portions of the embodiments and combination of elements of different embodiments as come within the scope of the following claims.

1. An article comprising:
an extruded profile composed of a crosslinked composition formed from starting materials comprising
an ethylene-based polymer; and
2,2,6,6-tetramethyl-4-piperidyl methacrylate disulfide (BiTEMPS methacrylate).

2. The article of claim 1 wherein the crosslinked composition comprises linkages of Structure 2

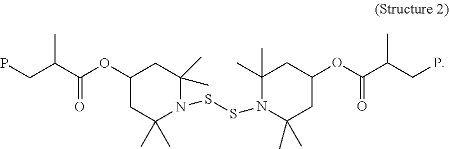

3. The article of claim 1 wherein the crosslinked composition comprises
from 80 wt % to 99 wt % of an ethylene-based polymer having a melt index from 0.1 g/10 min to 100 g/10 min; and
from 20 wt % to 1 wt % of the BiTEMPS methacrylate.

4. The article of claim 1 wherein the ethylene-based polymer is selected from the group consisting of ethylene plastomer/elastomer, high density polyethylene (HDPE), linear low density polyethylene (LLDPE), low density polyethylene (LDPE), ethylene/α-olefin multi-block copolymer, and combinations thereof.

5. The article of claim 1 wherein
the ethylene-based polymer is a virgin ethylene-based polymer prior to the crosslinked composition being crosslinked; and
the crosslinked composition has
(i) a storage modulus value, G′, at 140° C. that is greater than the storage modulus value, G′, for the virgin ethylene-based polymer at 140° C.;
(ii) a tan delta value at 60° C. that is less than the tan delta value of the virgin ethylene-based polymer at 60° C.; and
(iii) a tan delta value at 140° C. that is less than the tan delta value of the virgin ethylene-based polymer at 140° C.

6. An article comprising:
an extruded profile composed of a crosslinked composition comprising
an ethylene-based polymer; and
linkages having a Structure 2

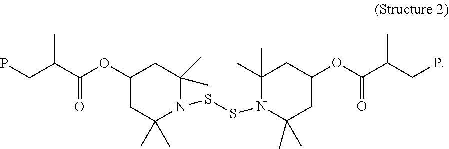

7. A process comprising:
heating a first article to a reprocessing temperature, the first article composed of an extruded profile composed of a crosslinked composition comprising
(i) an ethylene-based polymer; and
(ii) linkages of Structure 2 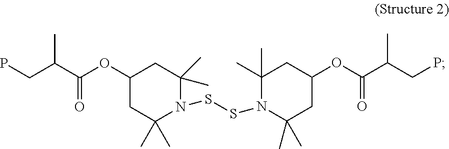
forming, at the reprocessing temperature, the first article into a re-processable ethylene-based polymer composition;
shaping, at the reprocessing temperature, the re-processable ethylene-based composition into a re-processed pre-form; and
cooling the re-processed pre-form to below the reprocessing temperature and forming a second article composed of a re-crosslinked ethylene-based polymer composition composed of (i) the ethylene-based polymer and (ii) linkages having the Structure 2.
